(19) United States
(12) Patent Application Publication
(10) Pub. No.: US 2026/0308389 A1
(43) Pub. Date: Oct. 8, 2026

(54) WATER-BASED NON-SKINNING SEALANT AND METHOD OF MAKING THE SAME

(71) Applicant: Tremco CPG Inc., Beachwood, OH (US)

(72) Inventors: Louis FERRI, Solon, OH (US); Maneesh BAHADUR, Midland, MI (US)

(73) Assignee: Tremco CPG Inc., Beachwood, OH (US)

(21) Appl. No.: 19/482,980

(22) PCT Filed: May 15, 2023
(86) PCT No.: PCT/US2023/022254

§ 371 Date: Nov. 10, 2025

(51) Int. Cl. C09D 5/02; C09D 7/45; C09D 7/65; C09D 151/00

(52) U.S. Cl. CPC C09D 5/022; C09D 5/024; C09D 7/45; C09D 7/65; C09D 151/003

(57) ABSTRACT

A non-curing sealant comprises a mixture of (i) an aqueous emulsion comprising a modified butyl rubber and a plasticizer and (ii) at least one additive selected from the group consisting of a corrosion inhibitor, an anti-foamer, a stabilizer, an anti-microbial agent, a filler, a rheology modifier, and combinations thereof. The plasticizer is present in an amount (wt. % of solids) greater than or equal to an amount of butyl rubber in the non-curing sealant. The modified butyl rubber is modified by having a reduced molecular weight and, optionally, having a free-radically reactive silane, acrylic acid, acrylic ester, or maleic anhydride moiety grafted thereon.

### BACKGROUND

Non-skinning sealants are typically made by solvating high molecular weight rubber in solvents and formulating the sealant from that rubber solution. However, such non-skinning sealants typically include a significant amount of volatile organic compounds (VOCs), which can be detrimental to the environment. Accordingly, there remains a need for alternative non-skinning sealants and method of making the same.

### SUMMARY

The following is a brief summary of subject matter that is described in greater detail herein. This summary is not intended to be limiting as to the scope of the claims.

According to a first aspect of the present disclosure, a non-curing sealant comprises a mixture of: an aqueous emulsion comprising a modified butyl rubber and a plasticizer, wherein the plasticizer is present in an amount (wt. % solids) greater than or equal to an amount (wt. % of solids) of butyl rubber in the non-curing sealant; and at least one additive selected from the group consisting of a corrosion inhibitor, an anti-foamer, a stabilizer, an anti-microbial agent, a filler, a rheology modifier, and combinations thereof.

In a second aspect of the present disclosure, a non-curing sealant comprises the non-curing sealant according to the first aspect, wherein the aqueous emulsion has a solids content of greater than 65 wt. %.

In a third aspect of the present disclosure, a non-curing sealant comprises the non-curing sealant according to any previous aspect, wherein the modified butyl rubber is present in an amount of from about 0.5 wt. % to about 35 wt. %, based on a total weight of the non-curing sealant.

In a fourth aspect of the present disclosure, a non-curing sealant comprises the non-curing sealant according to any previous aspect, wherein the plasticizer is present in an amount of from about 5.0 wt. % to about 50 wt. %, based on a total weight of the non-curing sealant.

In a fifth aspect of the present disclosure, a non-curing sealant comprises the non-curing sealant according to any previous aspect, wherein the aqueous emulsion further comprises at least one surfactant.

In a sixth aspect of the present disclosure, a non-curing sealant comprises the non-curing sealant according to any previous aspect, wherein the surfactant is present in an amount of from about 1.5 wt. % to about 15 wt. %, based on a total weight of the non-curing sealant.

In a seventh aspect of the present disclosure, a non-curing sealant comprises the non-curing sealant according to any previous aspect, wherein the modified butyl rubber comprises the reaction product of (i) a free-radical generator and (ii) a polymer selected from the group consisting of an isobutylene polymer, an isobutylene-isoprene copolymer, an isobutylene-paramethylstyrene copolymer, and combinations thereof.

In an eighth aspect of the present disclosure, a non-curing sealant comprises the non-curing sealant according to any previous aspect, wherein the polymer has an isobutylene content of 80 to 100 mol. %, based on the weight of the polymer.

In a ninth aspect of the present disclosure, a non-curing sealant comprises the non-curing sealant according to any previous aspect, wherein the modified butyl rubber comprises a free-radically reactive silane grafted on the polymer.

In a tenth aspect of the present disclosure, a non-curing sealant comprises the non-curing sealant according to any previous aspect, wherein the non-curing sealant is less than 100 ppm of volatile organic compounds (VOCs).

In an eleventh aspect of the present disclosure, an acoustical, metal building, or curtainwall sealant comprises the non-curing sealant according to any preceding aspect.

According to a twelfth aspect of the present disclosure, a method of making a non-curing sealant comprises: preparing a modified butyl rubber; emulsifying the modified butyl rubber and a plasticizer in water, thereby forming an aqueous emulsion; and compounding the aqueous emulsion into the non-curing sealant by adding at least one additive to the aqueous emulsion, wherein the at least one additive is selected from the group consisting of a corrosion inhibitor, an anti-foamer, a stabilizer, an anti-microbial agent, a filler, a rheology modifier, and combinations thereof.

In a thirteenth aspect of the present disclosure, a method comprises the method of the twelfth aspect, wherein the plasticizer is present in an amount greater than or equal to an amount of modified butyl rubber in the non-curing sealant.

In a fourteenth aspect of the present disclosure, a method comprises the method of the twelfth or thirteenth aspects, wherein the plasticizer is selected from the group consisting of naphthenic or paraffinic hydrocarbon oils, polybutenes, polyisobutylenes, esters compatible with polyisobutylene polymers and combinations thereof.

In a fifteenth aspect of the present disclosure, a method comprises the method of any one of the twelfth through fourteenth aspects, wherein preparing the modified butyl rubber comprises the reacting a free-radical generator with a polymer selected from the group consisting of an isobutylene polymer, an isobutylene-isoprene copolymer, an isobutylene-paramethylstyrene copolymer, and combinations thereof at an elevated temperature.

In a sixteenth aspect of the present disclosure, a method comprises the method of any one of the twelfth through fifteenth aspects, wherein the polymer has an isobutylene content of 80 to 100 mol. %, based on the weight of the polymer.

In a seventeenth aspect of the present disclosure, a method comprises the method of any one of the twelfth through sixteenth aspects, wherein preparing the modified butyl rubber comprises reacting a butyl rubber with a free-radically reactive silane and a free-radical generator at an elevated temperature, thereby grafting the free-radically reactive silane onto the butyl rubber.

In an eighteenth aspect of the present disclosure, a method comprises the method of any one of the twelfth through seventeenth aspects, wherein the aqueous emulsion has a solids content of greater than about 65%.

In a nineteenth aspect of the present disclosure, a method comprises the method of any one of the twelfth through eighteenth aspects, wherein emulsifying the modified butyl rubber and the plasticizer in water comprises: blending the modified butyl rubber, the plasticizer, and at least one surfactant; and adding water to the blend to produce the emulsion.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### DETAILED DESCRIPTION

Various technologies pertaining to butyl rubber emulsions and sealants including the same are now described.

In various aspects of the present disclosure, a water-based sealant based on a diene-type rubber (e.g., butyl rubber) is effective to provide a non-skinning, flexible sealant suitable for acoustical, metal building, and curtainwall sealing applications without the use of VOCs. Additionally, in some aspects, the rubber can be modified with a silane, acrylic acid, acrylic ester, or maleic anhydride moiety to achieve particular properties, such as improved adhesion. In some aspects, the water-based sealant is made from an aqueous emulsion having a high solids content (e.g., greater than about 60 wt. % solids).

### Modified Butyl Rubber

The water-based sealants of the present disclosure are based on a modified butyl rubber emulsified in water. According to aspects of the present disclosure, the butyl rubber is modified from its original form by (1) reducing the molecular weight and/or (2) grafting a silane, acrylic acid, acrylic ester, or maleic anhydride moiety onto the backbone of the butyl rubber polymer.

The butyl rubber of the present disclosure is a polymer containing isobutylene mers. As used herein, the term “polymer” includes homopolymers, copolymers, terpolymers, and mixtures thereof. In aspects, the butyl rubber is an isobutylene homopolymer. In other aspects, the butyl rubber is a copolymer of isobutylene with a C₄ to C₁₄ conjugated diene. Typical such C₄ to C₁₄ conjugated dienes that can be incorporated into the butyl rubber include, by way of illustration and not limitation, isoprene, butadiene, 2,3-methyl butadiene, piperylene, 2,5-dimethylhexa-2,4-diene, cyclopentadiene, cyclohexadiene, and methylcyclopentadiene. For example, the butyl rubber can be an isobutylene-isoprene copolymer. In still further aspects, the butyl rubber is an isobutylene-paramethylstyrene copolymer. In aspects, the polymer has an isobutylene content of from 80 to 100 mol. %.

In some aspects, the butyl rubber is a copolymer of isobutylene with isoprene. The isobutylene is present in the copolymer in an amount of from about 80 mol. % to about 99.5 mol. %, and the isoprene is present in the copolymer in an amount of from about 0.5 mol % to about 20 mol. %, depending on the particular implementation. For example, in some aspects, the isoprene can be present in an amount of 0.5 mol. % to about 15 mol. %, from about 0.5 mol. % to about 4 mol. %, or from about 2 mol. % to about 3 mol. %, including any and all ranges and subranges therein, with the remainder being isobutylene. In some aspects, the isobutylene-isobutylene copolymer has an isoprene to isobutylene content of from about 1:199 to about 1:4, based on a total number of moles in the isobutylene-isoprene copolymer. For example, the isobutylene-isoprene copolymer can have an isoprene to isobutylene content of about 1:199, about 1:49, about 1:32, about 1:24, or about 1:4 based on a total number of moles in the isobutylene-isoprene copolymer, including any and all ranges and subranges therein. Commercially available butyl rubbers that are suitable for use in various aspects include, by way of example and not limitation, those available under the trade names EXXON Butyl 365, EXXON Butyl 065, and EXXON Butyl 268 (all available from ExxonMobil Chemical Company, Texas); X_BUTYL RB100, X_BUTYL RB301, and X_BUTYL RB402 (all available from Arlanxeo Group, Netherlands); BK 1675N, BK 1675P, and BK1675M (all available from Nizh USA, New York).

In various aspects of the present disclosure, the modified butyl rubber is the reaction product of a free-radical generator, a polymer selected from the group consisting of an isobutylene polymer, an isobutylene-isoprene copolymer, an isobutylene-paramethylstyrene copolymer, and combinations thereof, and, optionally, a free-radically reactive compound (e.g., vinyl silane), acrylic acid, acrylic ester (e.g., glycidol methacrylate) or maleic anhydride at an elevated temperature. The reaction of the polymer with the free-radical generator is effective to decrease the molecular weight of the butyl rubber. Without being bound by theory, it is believed that the relatively high amount of isobutylene monomers as compared to isoprene monomers enables the free-radical generator to have a cleaving effect (chain scission) on the copolymer (and, more specifically, the isobutylene), thereby reducing its molecular weight. In contrast, a larger relative amount of isoprene could lead to cross-linking of the copolymer (e.g., via radicalization of the isoprene monomers) and an increase in molecular weight.

In some aspects, reaction of the butyl rubber with the free-radical generator is effective to reduce the number average molecular weight (Mₙ) by at least about 30%, and in some aspects, by more than 50%, by more than 60%, or even by more than 75%. For example, in aspects, the butyl rubber can have a Mₙ of from about 300,000 to about 400,000 prior to modification and the modified butyl rubber has a Mₙ of about 60,000 to about 250,000 or from about 65,000 to about 200,000. However, it is contemplated that both the Mₙ of the butyl rubber and the Mₙ of the modified butyl rubber can vary depending on the particular implementation.

In various aspects, the free-radical generator generates free-radicals upon heating and can be selected from any of the known azo or diazo compounds, such as 2,2′-azobisisobutyronitrile and phenyl-azo-triphenylmethane. In aspects, the free-radical generator is selected from organic peroxides such as hydroperoxides, diacyl peroxides, ketone peroxides, peroxyesters, dialkyl peroxides, diaryl peroxides, aryl-alkyl peroxides peroxydicarbonates, peroxyketals, peroxy acids, acyl alkylsulfonyl peroxides and alkyl monoperoxydicarbonates. In other aspects, free-radicals can be generated through the use of gamma radiation techniques.

Specific examples of suitable peroxides which may be used in aspects of the disclosure include, but are not limited to, benzoyl peroxide, t-butyl peroxy o-toluate, cyclic peroxyketal, t-butyl hydroperoxide, t-butyl peroxypivalate, lauroyl peroxide and t-amyl peroxy 2-ethylhexanoate, 1,3-bis(t-butylperoxyisopropyl)benzene, 2,2,4-trimethylpentyl-2-hydroperoxide, 2,5-bis(t-butylperoxy)-2,5-dimethylhexyne-3, cumyl hydroperoxide, t-butyl peroxybenzoate and diisopropylbenzene mono hydroperoxide, and the like. In particular aspects, the peroxide is selected from dicumyl peroxide and di-t-butyl peroxide.

When a reactive silane, acrylic acid, acrylic ester, or maleic anhydride is present, the reaction can be effective to graft the moiety onto the backbone of the butyl rubber polymer. Accordingly, although the molecular weight of the butyl rubber polymer can be decreased by reaction with the free-radical generator, the grafting of the silane, acrylic acid, acrylic ester, or maleic anhydride moiety onto the polymer can lead to an overall increase in the molecular weight of the modified butyl rubber through reaction of the grafted moiety with another reactive species (e.g., a difunctional amine or water in the case of silanes) as compared to the butyl rubber polymer used as a starting material.

In aspects, the reactive silane includes free-radically reactive silanes. According to some aspects, the reactive silane includes an alkenyl group having a vinylic-type unsaturation. For example, the reactive silane can include a vinyl, allyl, butenyl, pentenyl, hexenyl, heptenyl, octenyl, or decenyl group. The reactive silane may also, in some aspects, include at least one unsaturated group and a hydrolyzable group bound to the silicon atom. Suitable unsaturated groups can include, by way of example and not limitation, alkyl groups having 1 to 20 carbon atoms (e.g., methyl, ethyl, propyl, butyl, pentyl, hexyl, octyl, decyl, and dodecyl groups), cycloalkyl groups, aryl groups having 6 to 12 carbon atoms (e.g., pheynyl, tolyl, and xylyl groups), aralkyl groups having 7 to 20 carbon atoms, halogenated alkyl groups having 1 to 20 carbon atoms, and halogenated aryl groups having 6 to 12 carbon atoms (e.g., chlorobenzyl and chloronaphthyl groups). Hydrolyzable groups can include, by way of example and not limitation, methoxy, ethoxy, propoxy, butoxy, acetoxy, and propionoxy groups. In certain aspects, the reactive silane is methacryloxypropyl trimethoxy silane, methylvinyldimethoxysilane, vinyltrimethoxy-silane, hexenyltrimethoxysilane, or vinyl silane. Commercially available reactive silanes that are suitable for use in various aspects include, by way of example and not limitation, those available under the trade names SILQUEST A-171, A-151, A-2171, and A-174 (all available from Momentive Performance Materials Inc., New York); JH-V171 (available from Jingzhou Jiangan Fine Chemical Co., Ltd., China) and VTMO (available from Evonik Industries, Germany).

When included, the reactive silane can be included in excess relative to the stoichiometric amounts of desired silyl grafts onto the modified butyl rubber. In aspects, the molar amount of reactive silane is from about 1 to about 10 times the molar amount of silyl groups in the modified butyl rubber. In some aspects, from about 15 to about 100 moles of the silane are used for each mole of butyl rubber. According to various aspects, the free-radical generator can be included in an amount sufficient to provide from about 0.001 to about 1 mole, or from about 0.01 to about 0.1 mole of free-radical generator for each mole of reactive silane included.

In other aspects, an acrylic acid, acrylic ester, or maleic anhydride moiety is grafted onto the backbone of the butyl rubber polymer. When included, the acrylic acid, acrylic ester, or maleic anhydride can be included in excess relative to the stoichiometric amounts of desired grafts onto the modified butyl rubber. In aspects, the molar amount of acrylic acid, acrylic ester, or maleic anhydride is from about 1 to about 10 times the molar amount of acrylic acid, acrylic ester, or maleic anhydride groups in the modified butyl rubber. In some aspects, from about 15 to about 100 moles of the acrylic acid, acrylic ester, or maleic anhydride are used for each mole of butyl rubber polymer. According to various aspects, the free-radical generator can be included in an amount sufficient to provide from about 0.001 to about 1 mole, or from about 0.01 to about 0.1 mole of free-radical generator for each mole of acrylic acid, acrylic ester, or maleic anhydride included.

In various aspects, the butyl rubber and the free-radical generator are reacted at elevated temperatures. The reaction can be carried out in any equipment conventionally used for mixing or blending components while heating, such as an internal mixer or a twin-screw extruder. The temperature during the reaction is, according to various aspects, from about 50° C. to about 300° C., from about 50° C. to about 250° C., from about 75° C. to about 300° C., from about 75° C. to about 250° C., from about 100° C. to about 300° C., or from about 100° C. to about 250° C., including any and all ranges and subranges therein. In aspects, the mixing of the butyl rubber and the free-radical generator is carried out at the elevated temperatures to activate the free-radical generator, although it is contemplated that the butyl rubber and free-radical generator can be blended first at a temperature that is below the decomposition temperature of the free-radical generator and subsequently heated to initiate the reaction.

Reaction of the butyl rubber, the free-radical generator, and the reactive silane, acrylic acid, acrylic ester, or maleic anhydride (if included) can be accomplished in batch or continuous fashion and can be carried out neat or in the presence of a solvent. In various aspects of the present disclosure, the modified butyl rubber is incorporated into an aqueous emulsion.

### Aqueous Emulsion

According to various aspects of the present disclosure, the modified butyl rubber is emulsified with one or more plasticizers and a surfactant in water to form an aqueous emulsion. In aspects, the aqueous emulsion has a high solids content, or a solids content of greater than 60 wt. %, greater than 65 wt. %, greater than 70 wt. %, greater than 75 wt. %, or even greater than 80 wt. %. For example, the aqueous emulsion can have a solids content of from about 60 wt. % to about 90 wt. %, from about 60 wt. % to about 85 wt. %, from about 60 wt. % to about 80 wt. %, from about 60 wt. % to about 75 wt. %, about 65 wt. % to about 90 wt. %, from about 65 wt. % to about 85 wt. %, from about 65 wt. % to about 80 wt. %, from about 65 wt. % to about 75 wt. %, from about 70 wt. % to about 90 wt. %, from about 70 wt. % to about 85 wt. %, from about 70 wt. % to about 80 wt. %, from about 70 wt. % to about 75 wt. %, from about 75 wt. % to about 90 wt. %, from about 75 wt. % to about 85 wt. %, or from about 75 wt. % to about 80 wt. %, including any and all ranges and subranges therein.

The term “surfactant” is meant to describe a surface active agent selected from cationic surfactants, anionic surfactants, amphoteric surfactants, nonionic surfactants, and mixtures thereof which stabilize the dispersed phase of the emulsion. Particular surfactants that are suitable for use include those that are known in the art as being useful in stabilizing emulsions of elastomeric polymers. Examples of commercially available surfactants that can be used in various implementations include, by way of example and not limitation, polyoxyethylene vegetable-based fatty ethers derived from lauryl, cetyl, stearyl and oleyl alcohols, such as those surfactants available under the tradename BRIJ from Croda Inc., including BRIJ L4, BRIJ L23-69, and BRIJ 010.

In general, the amount of surfactant included in the aqueous emulsion can be from about 3 to about 30 parts by weight, from about 5 to about 15 parts by weight, or from about 5 to about 10 parts by weight, based on 100 parts of modified butyl rubber.

As used herein, the term “plasticizer” is used to describe an additive that is effective to reduce the viscosity of the modified butyl rubber, renders the modified butyl rubber flexible and easier to process, lowers the softening temperature of the modified butyl rubber, or increases the melt-flow characteristics of the modified butyl rubber. Plasticizers can include, by way of example and not limitation, naphthenic or paraffinic hydrocarbon oils, polybutenes, polyisobutylenes, esters compatible with polyisobutylene polymers, and combinations thereof. Esters compatible with polyisobutylene polymers are, in general, those esters that are based on alcohols having a carbon chain length of greater than or equal to 8 carbons. Other plasticizers can be employed, provided that they are compatible with the modified butyl rubber compound and capable of being emulsified in water. In aspects, the plasticizer is present in the non-curing sealant in an amount (based on weight of solids, or wt. % solids) that is greater than or equal to the amount of modified butyl rubber.

To prepare the emulsion, in various aspects, the modified butyl rubber, the plasticizer, and at least one surfactant are blended together, after which water is added to the blend to produce the aqueous emulsion. In some aspects, a small (e.g., from about 1.0 g to about 1.5 g) of an acid, such as acetic acid, can be added to the modified butyl rubber prior to the addition of any water to reduce the propensity of the silane molecules to hydrolyze and react in the emulsion. The amount of water added to the blend is dependent on the final desired solids content. In aspects, the modified butyl rubber, the plasticizer, and the surfactant are mixed together to form a premix to which is added with further mixing the water component. The plasticizer and surfactant can be added simultaneously or separately to the modified butyl rubber. In various aspects, the water is added in a stepwise fashion. Although it is contemplated that the water can be added in a single step, it is believed that incremental addition of the water can enhance the stability of the emulsion.

The mixing of the various components of the aqueous emulsion can be accomplished by any method known in the art, particularly those methods well-suited for the mixing of high viscosity materials. Mixing can be performed batchwise or in a semi-continuous or continuous manner using suitable equipment, including but not limited to, change-can mixers, double-planetary mixers, conical screw mixers, ribbon blenders, Banbury-type and Henschel type mixers, single screw or twin screw extruders, twin-rotor continuous mixers, or combinations thereof. Rotor-stator, colloid mills, homogenizers, or sonolaters can alternatively be used.

The emulsification process can be performed at ambient pressure and temperature, in various aspects. However, in some aspects, the temperature of the emulsification can be controlled to be below about 60° C. in order to minimize undesirable side effects and to counteract any temperature increase resulting from the mechanical energy associated with shearing high viscosity materials.

### Non-Curing Sealant

According to various aspects, the aqueous emulsion is compounded into a one-component, non-curing sealant by adding at least one additive to the aqueous emulsion. As used herein, a “non-curing sealant” refers to a sealant that remains uncured and soft after application and does not harden. Additives include those known and used in the art to form sealants, and can include at least one additive selected from the group consisting of corrosion inhibitors, anti-foamers, stabilizers, anti-microbial agents, preservatives, fillers, rheology modifiers, and combinations thereof.

Fillers can include, by way of example and not limitation, clays, talc, calcium carbonate, wood fiber, cellulose, or low density such as microballoons. Such fillers can be used to add volume and solids to the sealant composition. In general, when included in the sealant composition, fillers can be added in an amount of from about 5 wt. % to about 70 wt. % based on a total weight of the sealant composition. For example, fillers can be included in the sealant composition in an amount from about 5 wt. % to about 70 wt. %, from about 5 wt. % to about 60 wt. %, from about 5 wt. % to about 50 wt. %, from about 5 wt. % to about 40 wt. %, from about 5 wt. % to about 30 wt. %, from about 5 wt. % to about 20 wt. %, from about 10 wt. % to about 70 wt. %, from about 10 wt. % to about 60 wt. %, from about 10 wt. % to about 50 wt. %, from about 10 wt. % to about 40 wt. %, from about 10 wt. % to about 30 wt. %, from about 10 wt. % to about 20 wt. %, from about 15 wt. % to about 70 wt. %, from about 15 wt. % to about 60 wt. %, from about 15 wt. % to about 50 wt. %, from about 15 wt. % to about 40 wt. %, from about 15 wt. % to about 30 wt. %, or from about 15 wt. % to about 20 wt. %, based on a total weight of the sealant composition, including any and all ranges and sub-ranges therein.

Viscosity and rheology modifiers can be added to achieve an appropriate flow and hold or leveling, depending on the intended end use of the sealant composition. In some aspects, additional plasticizers and water can be added to decrease the viscosity of the sealant composition. When included, viscosity and rheology modifiers can be present in the sealant composition in an amount of from greater than 0 wt. % to about 5 wt. %, from greater than 0 wt. % to about 4 wt. %, from greater than 0 wt. % to about 3 wt. %, from about 0.5 wt. % to about 5 wt. %, from about 0.5 wt. % to about 4 wt. %, from about 0.5 wt. % to about 3 wt. %, from about 1 wt. % to about 5 wt. %, from about 1 wt. % to about 4 wt. %, or from about 1 wt. % to about 3 wt. %, based on a total weight of the sealant composition, including any and all ranges and sub-ranges therein.

Adhesion promoters, anti-foamers, stabilizers, anti-microbial agents, preservatives and corrosion inhibitors can also be added. When present, these additives can each be included in the sealant in amounts of greater than 0 wt. % to about 5 wt. %, from greater than 0 wt. % to about 3 wt. %, from greater than 0 wt. % to about 2 wt. %, from greater than 0 wt. % to about 1 wt. %, or from greater than 0 wt. % to about 0.5 wt. %, depending on the total weight of the sealant composition, including any and all ranges and sub-ranges therein.

In various aspects, the modified butyl rubber is present in an amount of from about 0.5 wt. % to about 35 wt. %, based on a total weight of the sealant composition. For example, the modified butyl rubber can be included in the sealant composition in an amount of from about 0.5 wt. % to about 35 wt. %, from about 0.5 wt. % to about 30 wt. %, from about 0.5 wt. % to about 25 wt. %, from about 0.5 wt. % to about 20 wt. %, from about 0.5 wt. % to about 15 wt. %, from about 0.5 wt. % to about 10 wt. %, from about 1 wt. % to about 35 wt. %, from about 1 wt. % to about 30 wt. %, from about 1 wt. % to about 25 wt. %, from about 1 wt. % to about 20 wt. %, from about 1 wt. % to about 15 wt. %, from about 1 wt. % to about 10 wt. %, from about 2.5 wt. % to about 35 wt. %, from about 2.5 wt. % to about 30 wt. %, from about 2.5 wt. % to about 25 wt. %, from about 2.5 wt. % to about 20 wt. %, from about 2.5 wt. % to about 15 wt. %, from about 2.5 wt. % to about 10 wt. %, from about 5 wt. % to about 35 wt. %, from about 5 wt. % to about 30 wt. %, from about 5 wt. % to about 25 wt. %, from about 5 wt. % to about 20 wt. %, from about 5 wt. % to about 15 wt. %, from about 5 wt. % to about 10 wt. %, from about 10 wt. % to about 35 wt. %, from about 10 wt. % to about 30 wt. %, from about 10 wt. % to about 25 wt. %, from about 10 wt. % to about 20 wt. %, or from about 10 wt. % to about 15 wt. %, based on a total weight of the sealant composition, including any and all ranges and sub-ranges herein.

According to aspects described herein, the total amount of plasticizer present in the sealant composition is from about 5 wt. % to about 60 wt. %, based on a total weight of the sealant composition. For example, the plasticizer can be included in the sealant composition in an amount of from about 5 wt. % to about 60 wt. %, from about 5 wt. % to about 65 wt. %, from about 5 wt. % to about 50 wt. %, from about 5 wt. % to about 45 wt. %, from about 5 wt. % to about 40 wt. %, from about 10 wt. % to about 60 wt. %, from about 10 wt. % to about 65 wt. %, from about 10 wt. % to about 50 wt. %, from about 10 wt. % to about 45 wt. %, from about 10 wt. % to about 40 wt. %, 15 wt. % to about 60 wt. %, from about 15 wt. % to about 65 wt. %, from about 15 wt. % to about 50 wt. %, from about 15 wt. % to about 45 wt. %, from about 15 wt. % to about 40 wt. %, 20 wt. % to about 60 wt. %, from about 20 wt. % to about 65 wt. %, from about 20 wt. % to about 50 wt. %, from about 20 wt. % to about 45 wt. %, or from about 20 wt. % to about 40 wt. %, based on a total weight of the sealant composition, including any and all ranges and sub-ranges therein.

Surfactant can be included in the sealant composition in an amount of from about 1.5 wt. % to about 15 wt. %, based on a total weight of the sealant composition. For example, in various aspects, the total amount of surfactant included in the sealant composition can be from about 1.5 wt. % to about 15 wt. %, from about 1.5 wt. % to about 12 wt. %, from about 1.5 wt. % to about 10 wt. %, from about 1.5 wt. % to about 7.5 wt. %, from about 1.5 wt. % to about 5 wt. %, from about 2 wt. % to about 15 wt. %, from about 2 wt. % to about 12 wt. %, from about 2 wt. % to about 10 wt. %, from about 2 wt. % to about 7.5 wt. %, from about 2 wt. % to about 5 wt. %, from about 3 wt. % to about 15 wt. %, from about 3 wt. % to about 12 wt. %, from about 3 wt. % to about 10 wt. %, from about 3 wt. % to about 7.5 wt. %, or from about 3 wt. % to about 5 wt. %, based on a total weight of the sealant composition, including any and all ranges and sub-ranges therein.

Conventional non-skinning sealants can include high molecular weight rubber solvated in solvents. In order to enable these compositions to be dispensed, these conventional compositions typically include a significant amount of volatile organic compounds (VOCs), which can be problematic for the environment. The modified butyl rubber of the present disclosure can be emulsified without the use of VOCs or other, non-aqueous solvents. Thus, according to aspects described herein, the sealant composition is substantially free or free of VOCs. For example, in aspects, the sealant composition contains less than 1000 ppm, less than 500 ppm, less than 100 ppm, or even less than 50 ppm of VOCs. As used herein, the phrase “free of VOCs” means that VOCs are not added to the butyl rubber, plasticizer, and surfactant premix or the sealant composition.

Various aspects of the sealant composition described herein provide a non-skinning sealant. Without being bound by theory, it is believed that the modified butyl rubber, and specifically, the reduction of the molecular weight of the butyl rubber, provides a polymer that is a semi-solid and flows when left out on a horizontal surface. Because this material is semi-solid, it is tacky, which keeps the sealant from forming a hard surface once the water has evaporated from the sealant composition. Surprisingly, it is also possible to achieve the non-skinning effect with systems including a butyl rubber that includes a free-radically reactive silane, acrylic acid, acrylic ester, or maleic anhydride moiety due to the plasticizer content of the aqueous emulsion. In particular, it is believed that the high plasticizer content softens the modified butyl rubber polymer to keep the modified butyl rubber in a plasticized state that remains soft and non-skinning.

In aspects, the sealant composition provides a sealant that is non-sagging, non-skinning, and/or non-curing. Accordingly, in aspects, the sealant can be subjected to movements due to thermal expansion, flexing, and the like, generally of less than 10% of a joint width in which the sealant is disposed. For example, the sealant can freely move during expansion of the joint and re-bond to itself as the joint compresses, repairing any tears that occurred during joint expansion. Accordingly, in some aspects, the sealant composition particularly well-suited for use in acoustical sealant, metal building sealant, or curtainwall sealant applications.

The general inventive concepts have been described above both generally and with regard to various specific aspects. Although the general inventive concepts have been set forth in what are believed to be exemplary illustrative aspects, a wide variety of alternatives will be apparent to those of skill in the art from reading this disclosure. The general inventive concepts are not otherwise limited, except for those instances when presented in specific claims.

### EXAMPLES

The following examples are included for the purposes of illustration, and does not limit the scope of the general inventive concepts described herein.

### Example 1

In a sigma-type lab mixer, approximately 800 grams of butyl rubber was added to a heated mixer (set to approximately 380° F.) and mixed until the large chunks of rubber were reduced in size and passed back and forth between the blades. Approximately 80 grams of dicumyl peroxide was added to the mixing butyl rubber and allowed to mix. The two materials were allowed to mix for 60 minutes at 380° F., after which the reduced molecular weight rubber was removed from the mixer and stored in an air-tight container.

### Example 2

In a sigma-type lab mixer, approximately 800 grams of butyl rubber was added to a heated mixer (set to approximately 380° F.) and mixed until the large chunks of rubber were reduced in size and passed back and forth between the blades. Approximately 80 grams of dicumyl peroxide was added to the mixing butyl rubber and allowed to mix. Within minutes of adding the peroxide, 60 grams of vinyl methyl dimethoxy silane was added to the mixer and the materials were allowed to mix for 60 minutes at 380° F., after which the grafted, reduced molecular weight rubber was removed from the mixer and stored in an air-tight container.

### Example 3

To manufacture the butyl rubber emulsion a Cowles-type high speed disperser was used. Approximately 450 grams of polybutene-type oil (e.g., Ineos H-300 polybutene) was added to a gallon can. Approximately 150 grams of the reduced-molecular weight butyl rubber of Example 1 was added to the gallon can and dispersed in the oil. A series of surfactants was then added to the mix. The surfactants were non-ionic ethylene oxide type surfactants: 15 grams of Brij L4, 25 grams of Brij L23-69, and 25 grams of Brij 010 (all available from Croda Inc.).

Once this mixture was mixing, about 280 grams of water was added slowly to create the emulsion. The water was added in small increments to achieve a stable emulsion. Once all of the water was added, the emulsion was mixed for an additional 5 to 10 minutes to achieve a uniform dispersion of polymer micelles. The resultant product was an approximately 70% solids butyl rubber emulsion.

### Example 4

A butyl rubber emulsion of Example 3 was added to a double planetary-type mixer with numerous compounding ingredients, including stabilizers, fillers, rheological additives, anti-foam agents, and biocides. The formulation is provided in Table 1.

TABLE 1

| Ingredients | Function | Amount (wt %) |
|---|---|---|
| Butyl Rubber Emulsion | | 68.5 |
| FoamMaster MO2185 | anti-foam | 0.02 |
| Mergal BIT20W | biocide | 0.1 |
| Propylene Glycol | stabilizer | 0.4 |
| Polyphase 663 | biocide | 0.15 |
| Suprex O Clay | filler | 30.0 |
| Bentone EW | rheological additive | 0.83 |

Upon completion of mixing of the above, a series of tests was performed to determine viability of the above sealant for use in situations where a non-curing sealant would be most useful. One test of the non-curing sealant variety is to determine if the systems cures or gets hard after it loses its volatile content (e.g., water or some type of solvent such as mineral spirits). To determine if the sealant hardens/cures with time, a simple cone penetration test is performed on material aged at elevated temperature for a prescribed time. The cone penetration test is performed similarly to ASTM D5 used for needle penetration with the needle being replaced by the cone used for ASTM D217 for cone penetration of greases. The cone is placed upon the surface of a container filled with the non-curing sealant and allowed to penetrate the sealant for 5 seconds like the needle penetration test. The total moving load on the cone is 300 grams. To accelerate this test, the sample was aged at an elevated temperature (88° C.) for at least two weeks (Sample A) and compared to a sample that was not accelerated by elevated temperature (Sample B).

To run this test six ounces of material was filled into a seamless steel container and the top surface leveled to achieve a flat surface. A comparative sample was kept at room temperature and another sample is maintained at elevated temperature for two weeks. The samples were removed from the elevated temperature (88° C.) oven and allowed to equilibrate to room temperature for 24 hours, after which the cone penetration test was run. The results are provided in Table 2. A commercially available non-curing sealant, Tremco JS-773, was used as for Comparative Sample A (accelerated aging) and Comparative Sample B (room temperature). JS-773 is a non-curing sealant is based on a hydrocarbon based solvent dilution of butyl rubber.

| | Cone Penetration | Delta RT- | Percent |
|---|---|---|---|
| Sample | Value | 88° C. | Delta |
| Comparative Sample B | 238 | 51 | 21.5 |
| Comparative Sample A | 187 | | |
| Sample B | 192 | 40.7 | 21.2 |
| Sample A | 151 | | |

As can be seen from the reduced data the water-based non-curing butyl rubber-based sealant behaves similarly to commercially available solvent borne non-curing sealants.

Another method to determine if a system is non-curing is by running a tack-free test according to ASTM D2377. This test is performed by placing a polyethylene film over a sample of the sealant and placing a weight onto the polyethylene for a known amount of time. The weight is removed and the polyethylene is peeled off the sample at a right angle from the sample surface. A system that is non-curing transfers some of the sealant onto the polyethylene. If the polyethylene comes away clean, the sealant has hardened on the surface and could be considered cured. The test samples are typically conditioned at elevated temperatures to drive off the volatile components prior to testing the tack of the surface.

When the water-based non-curing sealant of the above formulation (inventive Example 3) was conditioned for 14 days at 88° C. and then subjected to the tack-free test, the polyethylene contained traces of the sealant when it was removed, indicating that the sealant was not hardening with time and can be considered non-curing.

In the foregoing description, for purposes of explanation, numerous specific details are set forth in order to provide a thorough understanding of one or more aspects. It may be evident, however, that such aspect(s) may be practiced without these specific details. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Additionally, as used herein, the term “exemplary” is intended to mean serving as an illustration or example of something, and is not intended to indicate a preference.

What has been described above includes examples of one or more aspects. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A non-curing sealant comprising a mixture of:
an aqueous emulsion comprising a modified butyl rubber and a plasticizer, wherein the plasticizer is present in an amount (wt. % solids) greater than or equal to an amount (wt. % of solids) of butyl rubber in the non-curing sealant; and
at least one additive selected from the group consisting of a corrosion inhibitor, an anti-foamer, a stabilizer, an anti-microbial agent, a filler, a rheology modifier, and combinations thereof.

2. The non-curing sealant according to claim 1, wherein the aqueous emulsion has a solids content of greater than 65 wt. %.

3. The non-curing sealant according to claim 1, wherein the modified butyl rubber is present in an amount of from about 0.5 wt. % to about 35 wt. %, based on a total weight of the non-curing sealant.

4. The non-curing sealant according to claim 1, wherein the plasticizer is present in an amount of from about 5.0 wt. % to about 50 wt. %, based on a total weight of the non-curing sealant.

5. The non-curing sealant according to claim 1, wherein the aqueous emulsion further comprises at least one surfactant.

6. The non-curing sealant according to claim 5, wherein the surfactant is present in an amount of from about 1.5 wt. % to about 15 wt. %, based on a total weight of the non-curing sealant.

7. The non-curing sealant according to claim 1, wherein the modified butyl rubber comprises the reaction product of (i) a free-radical generator and (ii) a polymer selected from the group consisting of an isobutylene polymer, an isobutylene-isoprene copolymer, an isobutylene-paramethylstyrene copolymer, and combinations thereof.

8. The non-curing sealant according to claim 7, wherein the polymer has an isobutylene content of 80 to 100 mol. %, based on the weight of the polymer.

9. The non-curing sealant according to claim 1, wherein the modified butyl rubber comprises a free-radically reactive silane grafted on the polymer.

10. The non-curing sealant according to claim 1, wherein the non-curing sealant is less than 100 ppm of volatile organic compounds (VOCs).

11. An acoustical, metal building, or curtainwall sealant comprising the non-curing sealant according to claim 1.

12. A method of making a non-curing sealant comprising:
preparing a modified butyl rubber;
emulsifying the modified butyl rubber and a plasticizer in water, thereby forming an aqueous emulsion; and
compounding the aqueous emulsion into the non-curing sealant by adding at least one additive to the aqueous emulsion, wherein the at least one additive is selected from the group consisting of a corrosion inhibitor, an anti-foamer, a stabilizer, an anti-microbial agent, a filler, a rheology modifier, and combinations thereof.

13. The method according to claim 12, wherein the plasticizer is present in an amount greater than or equal to an amount of modified butyl rubber in the non-curing sealant.

14. The method according to claim 12, wherein the plasticizer is selected from the group consisting of naphthenic or paraffinic hydrocarbon oils, polybutenes, polyisobutylenes, esters compatible with polyisobutylene polymers and combinations thereof.

15. The method according to claim 12, wherein preparing the modified butyl rubber comprises the reacting a free-radical generator with a polymer selected from the group consisting of an isobutylene polymer, an isobutylene-isoprene copolymer, an isobutylene-paramethylstyrene copolymer, and combinations thereof at an elevated temperature.

16. The method according to claim 15, wherein the polymer has an isobutylene content of 80 to 100 mol. %, based on the weight of the polymer.

17. The method according to claim 12, wherein preparing the modified butyl rubber comprises reacting a butyl rubber with a free-radically reactive silane and a free-radical generator at an elevated temperature, thereby grafting the free-radically reactive silane onto the butyl rubber.

18. The method according to claim 12, wherein the aqueous emulsion has a solids content of greater than about 65%.

19. The method according to claim 12, wherein emulsifying the modified butyl rubber and the plasticizer in water comprises:
blending the modified butyl rubber, the plasticizer, and at least one surfactant; and
adding water to the blend to produce the emulsion.
